(19) United States
(12) Patent Application Publication
(10) Pub. No.: US 2007/0168645 A1
(43) Pub. Date: Jul. 19, 2007

(54) Methods and arrangements for conditional execution of instructions in parallel processing environment

(75) Inventors: Karl Heinz Grabner, Probstdorf (AT); Robert Klima, Vienna (AT)

Correspondence Address: Alan Carlson, 6202 Lynn Lane, Lago Vista, TX, 78645, US

(73) Assignee: On Demand Microelectronics

(21) Appl. No.: 11/654,065

(22) Filed: Jan. 16, 2007

(30) Foreign Application Priority Data
Jan. 16, 2006 (AT) A 59/2006 G06F

(51) Int. Cl. G06F 15/00

(52) U.S. Cl. 712/24

(57) ABSTRACT

Methods and processor architectures for the execution of instruction having a condition are disclosed. Very long instruction words can be loaded from a memory unit into an instruction word decoder and the decoder can separate the VLIW into processable sequences. Each processable sequence can be processable by a processing unit among a plurality of processing units. Each processable sequence can be executed independently in the absence of a condition in the processable sequences, and when the processable sequences contain a condition, processing units can be logically coupled together to add processing resources to a processing intensive condition type code to assist in disposing of the conditional execution quickly by assigning these additional resources.

### FIELD OF THE INVENTION

The invention relates to parallel processing units and to conditional execution of instructions in a parallel processor architecture.

### BACKGROUND OF THE INVENTION

Methods and systems for parallel execution of computer instructions have been utilized for years. For example, patent WO 2004/01 5561 discloses a processor for parallel processing of instructions, particularly of VLIWs (very long instruction words) which are arranged in memory units where the instructions can be separated into processable segments. These instructions are transferred to execution units which process the instructions, where transfer units are provided, to transfer the instruction segments to the execution units.

If each parallel processing unit executes a different instruction on different data for each processing unit at the same time, i.e. at the same cycle, this is known as MIMD architecture (MIMD—Multiple Instruction Multiple Data). The term SIMD architecture (SIMD—Single Instruction Multiple Data) is defined as processing architecture, which use one single instruction on multiple parallel data streams simultaneously at each clock cycle. This is done by parallel execution of the same instruction in the parallel processing units. Sequential processing and generation of data can be referred to as “data flow.” Parallel processing units can work in an information stream completely in parallel and independently from each other, while the execute stages do not influence the execution of other stages within the same clock cycle.

Similar to other known processors, parallel processing has the disadvantage, that measurable idle time can result due to inefficient processing and reduced data throughput will occur when the instruction flow which is processed in the processing units is interrupted in the case of conditional instructions. Conditional instructions often require the code being loaded into the processing unit to change in sequence based on this conditional instruction or jump instructions, and other processing units must be idle during this period and ascertain arithmetic units or processing cells must be tarried.

As a result, in this case in many of the processing units no instruction processing takes place for one or more clock cycles. It would be desirable to redress this and to increase the number of instructions that can be processed per time unit, in order to attain higher processing speeds and a higher data throughput rate of the processor.

### SUMMARY OF THE INVENTION

The problems identified above are in large part addressed by the systems, methods, arrangements and media disclosed herein to provide processing unit coupling instructions that can reduce the idle time of processing units in a parallel processing environment. The coupling instructions can control parallel processing units and depending upon whether a condition of a conditional instruction has been met, or not met, a control unit can send coupling instruction to processing units, where multiple processing units can assist in processing instructions related to the conditional instruction preventing the instruction stream from being broken during execution of the conditional instructions.

Accordingly, parallel processing units can have an improved efficiency because the number of idle cycles for processing units can be greatly reduced. The grouping or coupling instructions can be performed by at least one control unit, which can be embodied as a logic circuit within an integrated circuit. The control unit can receive the appropriate information regarding how many and which processing unit should be coupled. For example, the control unit can receive coupling instructions from a decode module and when a specific condition occurs, the control unit can couple parallel processing units together such that processing groups can be created to process a condition and instructions related to the condition so that better processing efficiency can be attained.

In another embodiment, an apparatus for executing conditional instructions within a very large instruction word (VLIW) processor is disclosed. The VLIW processor apparatus can have a fetch stage, a decode stage, an execute stage, and a register set. The execute stage can contain a set of parallel processing units whereas, in one mode the units can execute different instructions received from the decode stage where the parallel processing units operate independently from each other. All processing units can access a register set containing the data to be processed where the register set can be common to the processing units. The instructions can be different and can be embedded into a VLIW.

In one embodiment, when a parallel processing unit receives and executes a condition or executes an instruction that contains a condition, the control unit can “temporarily” couple other processing units to the processing unit(s) based on the condition. The processing unit assigned the condition will be referred to herein as a distinguished processing unit. In response to a signal sent to the control unit, the control unit can control the coupling of the processing units and instruct a processing unit on whether to execute the current command, or not to execute the current command.

Coupling of processing units can occur whether or not the condition is true or false. If no coupling information is provided to the control unit, a preceding, neighboring or adjacent processing unit can be coupled to the distinguished processing unit in a default mode. Moreover, coupling of processing units to a distinguished processing unit can be fixed for the number of cycles, for example, the number of cycles required to complete a conditional execution. Coupling of processing units can generally be defined as logically connecting the processing units via a buffer or some combinational or decision logic, where, when a condition is confirmed by a distinguished processing unit, the distinguished processing unit can activate a coupled processing unit to process its instruction or instruct the coupled processing unit to pass its processed data to the next stage such as a memory stage.

The disclosed apparatus can couple independently working processing units when a condition is being or will be executed by a processing unit. The coupling can be fixed for a number of processor clock cycles per condition. The information provided in the VLIW to describe the dependencies for conditional execution can be kept to a minimum. The processing units can be automatically coupled to each other with an adjacent processing unit that has a next lowest number, if no coupling information is provided. In this case no information about coupling needs to be stored in the VLIW.

### BRIEF DESCRIPTION OF THE DRAWINGS

In the following the disclosure is explained in further detail with the use of preferred embodiments, which shall not limit the scope of the invention.

FIG. 1 is a block diagram of a processor architecture having parallel processing modules;

FIG. 2 is a block diagram of a processor core having a parallel processing architecture;

FIG. 3 depicts independent parallel execute operation of four parallel processing units;

FIG. 4 shows an exemplary diagram of fetch, decode, and execute stages of a parallel processing architecture;

FIG. 5 illustrates one example of a conditional execution of processing units coupled in pairs;

FIG. 6 shows one example of a conditional execution with multiple conditions;

FIG. 7 depicts one execution example of the conditional execution of six processing units coupled in pairs;

FIG. 8 shows an example of conditional execution using three conditions attached to one processing unit;

FIG. 9 shows an example of the conditional execution of two processing units attached to one condition, where an ‘if’-branch is executed if the condition is met, and an ‘else’-branch if it is not met;

FIG. 10 shows an example of the conditional execution of several processing units attached to one condition, where an ‘if’-branch is executed if the condition is met, and an ‘else’-branch if it is not met;

FIG. 11 shows an example of the conditional execution of multiple processing units attached to one condition as well as instructions from the decode and fetch stage;

FIG. 12 shows a flow diagram for conditional execution with causal coupling;

FIG. 13 shows a flow diagram for conditional execution of processing units using causal coupling; and

FIG. 14 shows a flow diagram for conditional execution not considering causal coupling.

### DETAILED DESCRIPTION OF THE PREFERRED EMBODIMENTS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims. The descriptions below are designed to make such embodiments obvious to a person of ordinary skill in the art.

While specific embodiments will be described below with reference to particular configurations of hardware and/or software, those of skill in the art will realize that embodiments of the present disclosure may advantageously be implemented with other equivalent hardware and/or software systems. Aspects of the disclosure described herein may be stored or distributed on computer-readable media, including magnetic and optically readable and removable computer disks, as well as distributed electronically over the Internet or over other networks, including wireless networks. Data structures and transmission of data (including wireless transmission) particular to aspects of the disclosure are also encompassed within the scope of the disclosure.

In one embodiment, methods, apparatus and arrangements for executing conditional instructions utilizing multi-unit processors that can execute very long instruction words (VLIW)s are disclosed. The processor can have a plurality of fetch modules to operate during a fetch stage, a decode module to decode during a decode stage, an execute module to perform an execute stage, and a register set to store data and instructions for the modules. The execute stage can utilize a set, or plurality of parallel processing units which, in a first operating mode, receive, and execute unrelated or different instructions.

The instructions can be received independently from the decode module performing the decode stage. The processing units can access the register set which can be commonly accessed by all processing units. Generally, many individual or functionally different instructions can be coded in the VLIW and some of the instructions can be conditional instructions or conditions. In a second mode, when at least one parallel processing unit receives a condition to process, other processing units can be temporarily coupled to the processing unit processing the conditional instruction responsive to instruction created by the control unit. The processing units that contain a condition are referred to herein as distinguished processing units and processing units that do not contain a condition can be referred to as non-distinguished processing units.

The control unit can receive information regarding which processing units are to be coupled to the distinguished processing unit(s). The distinguished processing units can send a signal to the control unit in response to the results of processing the condition regarding whether the executed condition created, e.g., a positive or negative/true or false result. Depending on the result signal, the control unit can control the coupled processing units to execute their contained instructions, to not execute their contained instruction, or to execute their current instruction regardless of the result signal.

If no coupling information is provided to the control unit, the preceding processing unit (the unit assigned a next lower number) can be coupled to a distinguished processing unit in a default mode. Moreover, coupling of processing units to a distinguished processing unit can be fixed for a certain number of cycles even in the case when processor instructions take only one cycle. It can be appreciated that the disclosed method and apparatus can logically couple independently working processing units when a conditional execution is present in a processing unit and such a process can be executed within a clock cycle. Also, an arbitrary number of processing units can be coupled to process a conditional instruction for more than one clock cycle and often no information about coupling needs to be contained in a VLIW for coupling to occur. If coupling information is contained in the VLIW, coupling information can be of minimal size (i.e. utilize only a very small number of bits in the word).

Due to this flexible coupling arrangement, a clear overview of the program flow can be achieved. Moreover, conditions utilized in the execute stage by the processing units can be related to instructions in the loading and/or decode stage, to avoid evaluating a condition multiple times. Such control could otherwise be processed in later clock cycles and such a feed-forward process for the instruction pipeline enhances the program flow.

In a preferred embodiment, a VLIW processor can make use of parallel processing units that operate on the same register set whereas the processor is used for image, video and/or signal processing applications. In order to provide a better understanding of the disclosure, the following will focus on some basic features of general processor architectures. In modern processing architectures, multiple processing units are arranged in parallel to increase data throughput. The increased data throughput is achieved by parallel and simultaneous execution of multiple instructions, whereby generally, every processing unit can execute one instruction per clock cycle.

One method to pass instructions from a central instruction memory to the parallel processing units which execute the instructions is to use VLIWs. VLIWs can contain the instruction words for all or each of the parallel processing units of the processor which are executed in one clock cycle. These VLIWs can be loaded to the processor using a central fetch stage for all of the processor's parallel processing units. The VLIWs are generally loaded from the instruction memory sequentially, creating a “program flow” or a “stream of instructions.”

In order to process the stream of instructions, a processor can utilize three stages: in the first stage, the fetch stage, an instruction word can be loaded to decode processing units, as mentioned above. The second stage, the decode stage, can separate the VLIW into individual instructions or sub instructions for each parallel processing unit. These sub-instructions can be utilized in the processing of the instructions in the following third stage, the execute stage. Each processing unit can then process an instruction during the execute stage. Each stage can perform its task within a single one clock cycle and transfers the result of the task to the next stage. Therefore, within one clock cycle, one instruction is executed in the execute stage for each parallel processing unit, while the next instruction is being prepared in the decode stage and the next instruction can be loaded from the instruction memory by the fetch stage. Such a system is referred to as having an “instruction pipeline.”

Often, when a conditional instruction is executed, and the result(s) are determined, then the processing unit must request and receive a portion of code that is somewhere in memory and hence not currently loaded in the pipeline. This can be referred to as a conditional jump. “Regular jumps” do not present a significant problem (i.e. processing inefficiency) for modern processing architectures provided that the jump address (address where the next instruction must be retrieved) does not have to be calculated. If the jump address is specified, the fetch stage in the next clock cycle can load the VLIW from the instruction memory and the processing unit can proceed utilizing the new instruction specified by the jump address. Hence, a regular jump can require no extra clock cycle and during such a jump the processing units may continuously execute instructions and produce results without requiring some processing units run idle.

When a processing unit encounters a “conditional jump” this can cause significant processing inefficiencies. The term “conditional jump” is defined where a processor must jump to an instruction word in the instruction memory depending upon a condition being met or a precondition being met. Alternately described, this branching decision can occur where the instruction may come from one of many different addresses if a precondition is fulfilled or not fulfilled, otherwise the next instruction word in the pipeline will be processed.

A conditional jump, and/or a regular jump, for which the jump address has to be calculated, adds further inefficiencies and cannot be performed as quickly as a regular jump where the address of the next instruction is predetermined, known or readily available. Accordingly it will take clock cycles for the designated processing unit of the execute stage to calculate the destination address for the jump. During the loading of the instructions to calculate the jump address and calculation of the jump address, normally all the processing units will be idle. It can be appreciated that a conditional jump where addresses have to be calculated can consume many clock cycles where all processing units are idle. Such idle assets significantly reduce the processing efficiency of the system. For example, in a video processing embodiment when many processing units are idle, it is possible that data throughput can be reduced so much that the video can become very distorted.

In such an operation, first the jump address must be calculated by the execute stage, and then the fetch stage can access and load the VLIW from the calculated address during the next clock cycle, then the VLIW must be decoded. Possibly only a small portion of the VLIW may be processed only by the designated processing unit. It can be a common occurrence that the three-stage pipeline, as described above, is interrupted for two clock cycles in this case, resulting in significant inefficiencies in processing, generally, measured in number of instructions per unit of time that are not performed by the available processing units.

In accordance with the present disclosure, a more efficient usage of processing units can be achieved by reducing idle clock cycles for processing units particularly when processing, among other things, conditional jumps. In one embodiment, conditional jumps can be anticipated or predicted and the jump address or addresses that may occur as a result of a conditional jump can be tracked by coupling non-distinguished processing units to provide a supporting role for the distinguished processor, eliminating idle cycles where only a single processing unit does all of the execution. Thus, processing units that are coupled to a distinguished processing unit (i.e. units coupled to a unit that has a conditional instruction loaded) can calculate possible jump addresses (the addresses of the next instruction words for both whether the condition is met or condition not met) and prepare the fetch and decode stages in a parallel operation such that the distinguished processing unit is not the only unit that is processing instructions and data.

Depending upon whether the condition has been met or not, the next instruction word for both results or any possible result can be loaded by the fetch stage and decoded by the decode stage wherein coupled processing units can facilitate such a process, where processing units will not, and do not remain idle during valuable clock cycles. One way to address acquiring instructions is to double-up the decode stage, but this can create a considerable increase of the complexity of the processing architecture. The disclosed method and apparatus can minimize idle clock cycles and turnover loss by using the possibility of coupling parallel processing units in the execute stage, which can utilize new programming concepts.

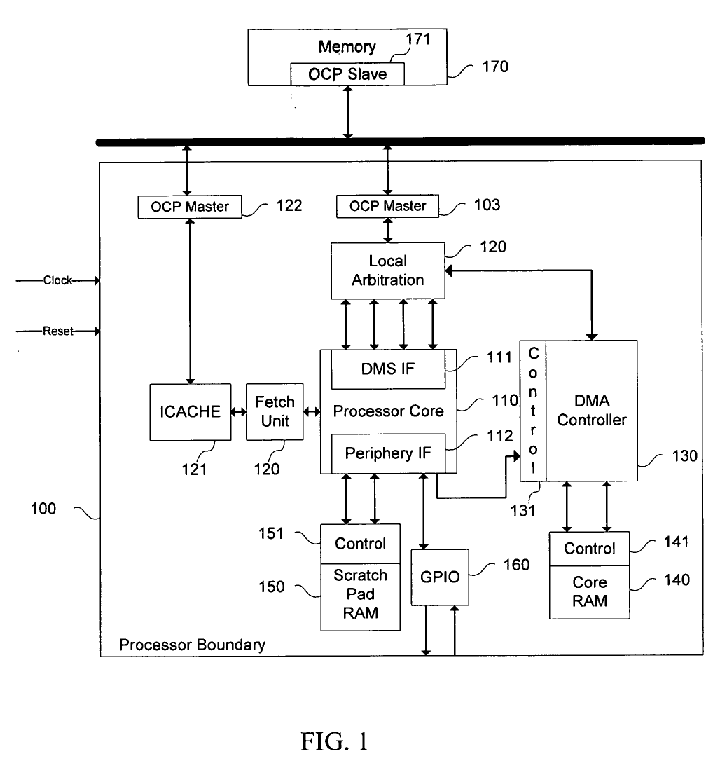

FIG. 1 shows a block diagram overview of a processor 100 which could be utilized to process image data, video data or perform signal processing, and control tasks. The processor 100 can include a processor core 110 which is responsible for computation and executing instructions loaded by a fetch unit 120 which performs a fetch stage. The fetch unit 120 can read instructions from a memory unit such as an instruction cache memory 121 which can acquire and cache instructions from an external memory 170 over a bus.

The external memory 170 can utilize OCP (Open Core Protocol) interface modules 122 and 171 to facilitate such an instruction fetch or instruction retrieval. In one embodiment the processor core 110 can utilize four separate ports to read data from a local arbitration module 120 whereas the local arbitration module 120 can schedule and access the external memory 170 using OCP interface modules 103 and 171. In one embodiment, instructions and the data are read over an OCP bus from the same memory 170 but this is not a limiting feature, instead any bus/memory configuration could be utilized such as a “Harvard” architecture for data and instruction access can be utilized.

The processor core 110 could also have a periphery bus which can be used to access and control a direct memory access (DMA) controller 130 using the control interface 131, a fast scratch pad memory over a control interface 151, and to communicate with external modules, a general purpose input/output (GPIO) interface 160. The DMA controller 130 can access the local arbitration module 120 and read and write data to and from the external memory 170. Moreover, the processor core 110 can access a fast Core RAM 140 to allow faster access to data. The scratch pad memory 150 can be a high speed memory that can be used to store intermediate results or data which is frequently utilized. The conditional execution method and apparatus according to the disclosure can be implemented in the processor core 110.

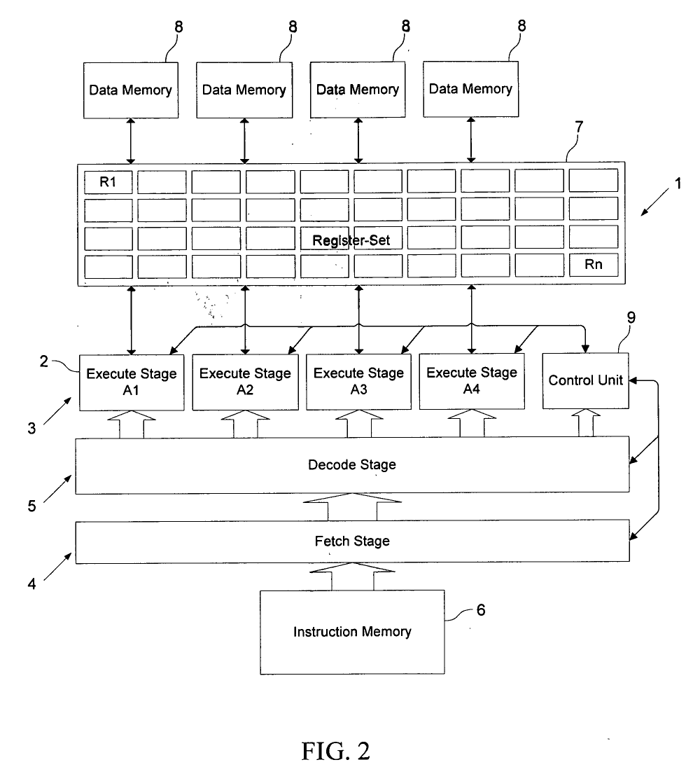

FIG. 2 shows an overview of a processor core 1 which can be part of a processor having a three-stage instruction processing pipeline. The processing pipeline can, include a fetch stage 4 to retrieve data and instructions, a decode stage 5 to separate very long instruction words (VLW) into units, processable by a plurality parallel processing units 21, 22, 23, and 24 in the execute stage 3. The actual length of the pipeline, i.e., the number of stages and the number of processing units which make up the pipeline would not be part from the scope of the present disclosure. Furthermore, an instruction memory 6, can store instructions and the fetch units 4 can load instructions into the decode units 5 from the instruction memory 6.

Further, data can be loaded from or written to data memories 8 from a register area or register set 7. Generally, data memories can provide data and can save the results of the arithmetic proceeding provided by the execute stage. The program flow to the parallel processing units 2 of the execute stage 3 can be influenced for every clock cycle with the use of at least one control unit 9. The architecture shown provides connections between the control unit 9, processing units and all of the stages 3, 4 and 5.

The control unit 9 can be implemented as a combinational logic circuit. It can receive instructions from the fetch 4 or the decode stage 5 (i.e. any stage previous to the execute stage 3, for the purpose of coupling processing units for specific types of instructions or instruction words for example for a conditional instruction. In addition, the control unit 9 can receive signals from an arbitrary number of individual or coupled parallel processing units 21-24, which can signal whether conditions are contained in the loaded instructions.

The control unit 9, in turn can send signals to all of the processing units 21-24 or to a selection of processing units 21-24 in order to control the operations in these processing units 21-24 or a selection of processing units 21-24 particularly when a conditional instruction is present within a processing unit. This control feature can be implemented in a way that the delay times of the processing pipeline can be minimized and the response times of the control unit 9 are shortened and the control of the execution stage is robust. As stated above the control unit 9 can receive control signals or instructions from the decode stage 5, and the processing units 2 of the execute stages 3 and make such control decisions.

The control unit 9 can receive status signals simultaneously from all parallel processing units 21-24, and it send individual control signals to all of the parallel processing units 21-24. The control unit 9 can also receive, where necessary, instructions for the interpretation of conditional execution of the processing units 21-24 from the decode stage 5. The corresponding information flows are highlighted in FIG. 2 with arrows.

The control unit 9 can control the program flow/instruction processing through each of the parallel processing units 21-24 and couple any of the plurality of processing units 21-24 to other processing units 21-24 for a predetermined number of clock cycles (i.e. one or many) when needed according to the program flow, which will be explained more closely in the figures below.

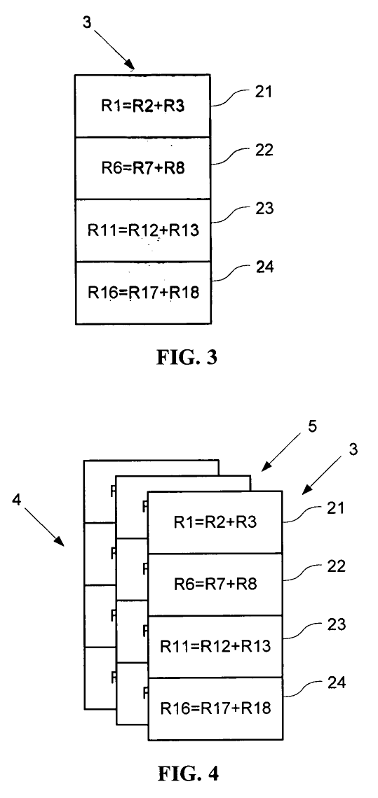

FIG. 3 shows, in simplified form an exemplary execute stage 3 of four processing units 21, 22, 23, and 24 (i.e. 21-24) arranged in a vertical format in order to simplify the description. In this embodiment, or first mode, each processing unit 21-24 can execute instructions independently from the other processing units in the group. For example, processing unit 21 can execute the instruction/function R1=R2=R3 and processing unit 22 can execute the instruction R6=R7=R8. This mode of operation is can be referred to as “non-jump” mode of operation or execution. In this mode, each processing unit 21-24 can be loaded with instructions to be executed from a decode stage (not shown), and execute the instruction utilizing data loaded from a register (not shown) that provides the R values for the variables in the instructions set. The decode stage and the registers were described above with reference to FIG. 2.

The register set R1 to Rn (item 7 in FIG. 2) can be a set of data that can be shared between all parallel processing units 21-24. When programming the codes in a higher level language and compiling the high level language to create machine code, care should be taken that two instructions executed in parallel do not influence the parallel processing units 21-24 by using the same register.

FIG. 4 shows, in addition to the execute stage 3, a decode stage 5 and a fetch stage 4 behind the execute stage 3. To simplify the teaching, only simple arithmetic operations or arithmetic instructions which are directly executed on the register set are used in this example, e.g., R1=R2+R3 etc. and other type instructions would not part from the scope of the present disclosure. The stages illustrate how the instructions move through the stages (i.e. pipeline) and the data that is required to fill the variable at the execute stage 3.

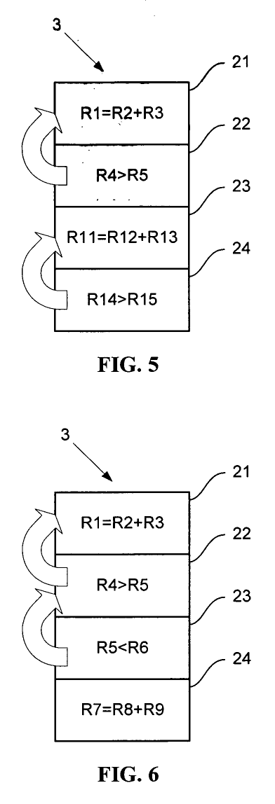

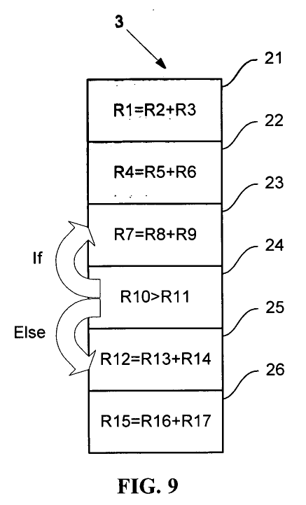

FIG. 5 through 11 are more closely based upon the processor architecture shown in FIG. 2 which is different to existing architectures in that the processing unit can operate in an independent mode and when a condition exists they can operate in a coupled mode to enhance or cooperate processing power for a complex conditional processing conditions. The multiple parallel processing units 21-24 can execute an instruction stream in a Single Instruction Multiple Data architecture (SIMD) or in a Multiple Instruction Multiple Data (MIMD) architecture. Sequential processing and generation of data is called a “data flow.”

The term SIMD-mode and MIMD-mode can both read, write, and/or process data from a register set or data from separated data memories 8. The n processing units 21-24 (in this example n=4) is no to be a limiting factor as only four processing units are illustrated herein to simplify the, description. In alternate embodiments more than seven processing units could be utilized. During execution of non-jump conditions, the processing units 2 in the execute stage 3 can each execute instructions which do not influence the program execution of the other parallel processing unit(s) 2. They therefore operate independently of one another in every clock cycle.

FIG. 5 illustrates a condition where conditional instructions are present in the execute stage and how coupling of processing units can be achieved. Processing units 22 and 24 each contain a conditional instruction, R4>R5 and R14>R15, respectively and processing units 21 and 23 each contain a different instruction (i.e. R1=R2+R3 and R11=R12+R13 respectively). Processing units which contain conditions (i.e. 22 and 24) are referred to herein as distinguished processing units because in the current clock cycle the units 22 and 24 may not calculate a result which is stored in memories or which set a flag, instead or in addition they may determine the execution of another processing units by means of a control unit (not shown).

The control unit can automatically couple processing units 21 and 22 together based on the conditional instruction in unit 22 and couple processing units 23 and 24 together based on the conditional instruction in unit of 24. From this coupling the following operations can result. If the condition in unit 22 (namely R4>R5) is true, then execute the instruction in 21. (i.e., calculate R1=R2+R3). If the condition in 24 (R14 >R15) is true, then execute the instruction in 22 (i.e. calculate R11=R12+13).

The control unit can take on further additional functions, not only the ones to control the conditional execution but also the total execution control of the execute stage. The control unit can receive signals from the decode stage and also from the processing units. In accordance with the present disclosure the control unit can receive information regarding which of the processing units 21-24 contain a condition and create the coupling between the processing units 21-24. If the control unit is not informed by certain signals originated, e.g., from the decode stage to a different behavior, i.e., if the control unit is in default mode, within each clock cycle the control unit can couple parallel processing units that contain a condition with the corresponding adjacent or previous processing unit, or a processing unit with the next lower number. In the example shown the processing unit 22 is coupled with processing unit 21 and the processing unit 24 is coupled with processing unit 23. These groups can then executed the instructions in parallel, i.e., concurrently but independently from each other.

In one embodiment, the processing unit can be arranged such that they have a hierarchy, and a convention can be utilized that a distinguished processing unit can in a default mode couple itself to a certain number of processing units that have the lower number in the hierarchy. The number or quantity of processing units for each condition can be determined by the control unit based on signals from the decode stage. If there is no quantity of processing units to be coupled for an indicated condition, the condition can be coupled only with the processing unit that is next in the hierarchy.

Conditional instructions can also be combined as shown in FIG. 6. Accordingly processing units 22 and 23 are distinguished processing units and contain conditional instructions. A control unit can automatically couple processing unit 22 with processing unit 21 and also processing unit 23 with processing unit 22. As a result, the expression found in 21 is only executed if both conditions executed by processing unit 22 and 23 are met. In this example, processing unit 24 does not follow any condition as the instruction is executed unconditionally. In accordance with FIG. 6, if the conditions in processing unit 22 (R4>R5) and processing unit 23 (R5<R6) are valid, then processing unit 21 will execute R1=R2+R3. Processing unit 24 will execute R7=R8+R9 in any case.

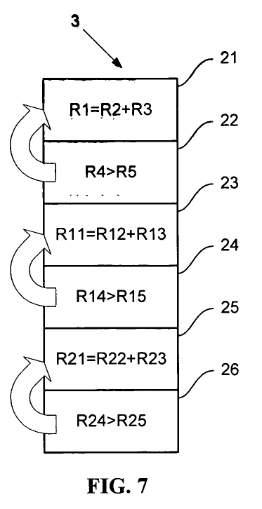

FIG. 7 shows an example with six parallel processing units 21, 22, 23, 24, 25, and 26 (21-26) whereby the processing units 22, 24, and 26 each contain one condition and can be automatically coupled (i.e., without any instructions to a control unit) to the previous processing unit with the next lower number in the hierarchy i.e. processing units 21, 23 and 25. The example in FIG. 7 can be interpreted as follows, if the condition processed by processing unit 22 is valid, then processing unit 21 will be executed, if the condition in processing unit 24 is valid, then the instruction loaded in processing unit 23 will be executed, and if the condition loaded in processing unit 26 is valid, then the instruction in processing unit 25 will be executed.

As described above, a control unit is responsible for the coupling of parallel processing units 2. Without instructions to a control unit, processing units can self couple a neighboring processing unit. The control unit can also be controlled by signals from the decode stage—which is the stage prior to execute stage—because it both controls the whole program flow as well as the coupling of parallel processing units 3. With special instructions from the decode stage, which expands this instructions from the VLIWs, the control unit can also be commanded to connect an arbitrary number of processing units 3 with those processing units 2 that contain the conditions.

In one embodiment, a convention can be adopted where designated processing units can be coupled to a specific number of processing units which are located adjacent to the designated processing units and when a numbering system or a hierarchy exists designating processing units a next lower or assigned non designated processing can be assigned.

Thus, processing units with lower numbers can be coupled when the conditions are valid. In another embodiment, the amount of processing units to be coupled for each condition in the implementation stage can be controlled by the control unit or by the decode stage. If no processing units are identified for coupling for a particular condition, the adjacent coupling methods could be utilized.

FIG. 7 illustrates six parallel processing units 21, 22, 23, 24, 25, and 26 whereby a processing unit 24, contains a condition and can “automatically” coupled itself (i.e., without any instructions to and from the control unit) to processing units with the next lower assigned number in the hierarchy (i.e. to processing units 23, 22 and 21). As a result if the condition in processing unit 24 is valid, then processing units 21-23 can execute their loaded instructions. If the condition in processing unit 24 is not valid, then processing units 21-23 will be idle.

As described above, a control unit can also be responsible for coupling processing units to the distinguished processing unit (i.e. processing unit 24). When no direct instructions are provided to/by the control unit, by default processing units that have been assigned, consecutively numbered processing units can automatically be couple to each other. In other embodiments, and according to instructions from the decode stage, which expands/separates VLIW instructions, the control unit can also be commanded to connect an arbitrary number of processing units with the distinguished processing units or that processing units that contain conditions.

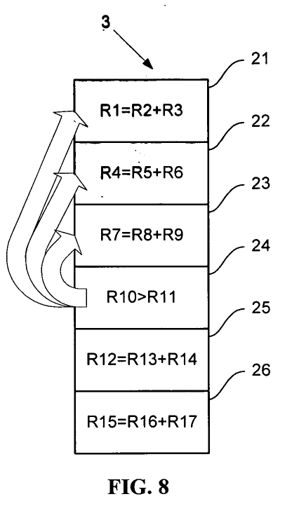

FIG. 8 shows an example where several processing units are coupled in an IF-ELSE embodiment. In this embodiment, the control unit can be commanded to connect several processing units through control unit based on a single condition. This coupling can be achieved not only for a valid condition but also when a non-valid or invalid condition occurs at the distinguished processor. Processing units 23 and 25, can be coupled to distinguished processing unit 24 based on the results of conditional instruction R10>R11 in distinguished processing unit 24. The instructions of the processing units 21, 22, and 26 can be executed unconditionally. Therefore, if the condition in processing unit 24 is valid, then processing unit 23 will execute and if the condition in processing unit 24 is not valid or false then processing unit 25 will execute while processing units 21, 22, and 26 will execute regardless of the conditional instruction.

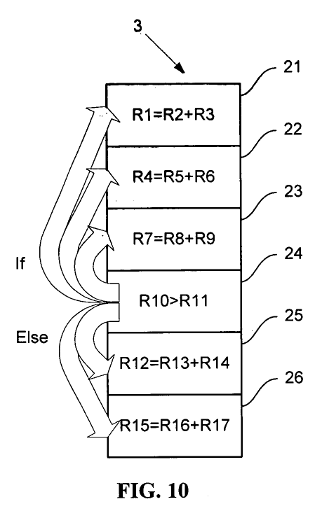

FIG. 10 illustrates an embodiment where the control unit receives instructions and has commanded three processing units 21, 22, and 23 to couple to distinguished processing unit 24 when an “if condition” is true and to couple designated processing unit 24 to processing units 25 and 26 when the “if condition” is false so the control can originate from the processing unit 24. In another embodiment the instructions of the processing units 25 and 26 can be executed unconditionally. Alternately described, if the condition in processing unit 24 is valid, then processing units 21, 22, and 23 will execute and processing units 25 and 26 will execute in any case.

A condition can also be coupled with the processing units if their operations have to be executed when the condition is not met. This mode of operation can also be controlled by signals via a control unit. The control unit can receive the instruction to control the processing units via the decode stage. The processing unit 24 can contain a condition (R10>R11). The processing unit 23, which is coupled to processing unit 24, may only execute its instruction if the condition stored in processing unit 24 is met. The processing unit 25, on the other hand, can be carried out if the condition according to processing unit 24 is not met. The instruction for conditional execution, which the control unit can receive from the decode stage, can be as follows, if the condition in processing unit 24 (i.e. R10>R11) is valid, processing unit 23 will execute (R7=R8+R9) otherwise processing unit 25 will execute (R12=R13+R14), where processing units 21, 22, and 23 will execute their instructions in any case.

It can be appreciated that a processing unit with a single condition can be coupled with to several processing units under the control of a control unit. This feature is not only applicable for the ‘if’-branch or the ‘true/yes’-branch, but it can also be applicable for the else-branch or the false/no branch.

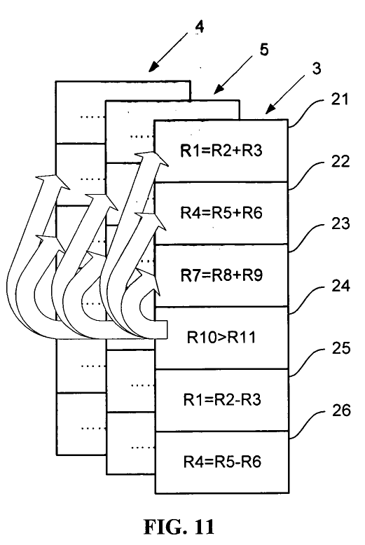

FIG. 10 shows an example in which all available processing units 21-26 which are coupled by a single conditional instruction from a single distinguished processor to 24 according to (R10>R11). In this example if the condition in processing unit 24 is valid, then processing units 21, 22, and 23 will execute their instruction, and processing units execute 25 and 26 will execute unconditionally. The instruction for the conditional execution, can again be received by the control unit from the decode stage, as the example in FIG. 11 is similar to the execute stage shown in FIG. 10.

It can be appreciated that the conditional execution of instructions described for parallel processing units provides significant improvements. On one hand, the full functionality of processing units can be used for the condition, but on the other hand the behavior of all other parallel processing units in a processor, which operate on the same register set, can be influenced for the same clock cycle. Moreover, all available processing units can easily be coupled to a “condition” that is processed by a designated processing unit.

A valid instruction could also be a jump instruction, i.e., an instruction can branch out to a different part in the program flow. A conditional jump can be executed like a regular, conditional instruction only, if the condition is valid in the designated processing unit which is coupled to another non-designated processing unit that has the jump instruction. The assignment of parallel processing units to conditional instructions can be carried out by control unit and its behavior, as explained above, can be influenced by instructions which are contained in the particular VLIW.

Control unit, however, can also establish a causally determined coupling of the condition, which is contained in a parallel processing unit 2, with the instructions that are executed in the following clock cycles. This happens in a way that control unit can be assigned to couple the condition of a processing unit 2 in the implementation stage 3 additionally or exclusively with one or more instructions, which are, e.g., contained in decode stage 5 and fetch stage 4 respectively, and which are executed with the following clock cycles. The instruction of decode stage 5 to the control unit can be, for instance: “3 processing units in execute, 2 in decode, and 2 in fetch stage in the ‘if’-branch”.

Controlled by the condition in the execute stage 3, the three processing units 2 with the next lower numbers as well as the two processing units 2 of both the decode stage 5 and of the fetch stage 4 with the next lower numbers in a position direct before the condition are executed. FIG. 11 shows an appropriate example, in which the condition of the processing unit 24 in the execute stage is coupled with the processing units 21, 22 and 23 in the execute stage as well as the processing units 22 and 23 in the following clock cycle (see decode stage 5) and also in the clock cycle after that (see fetch stage 4).

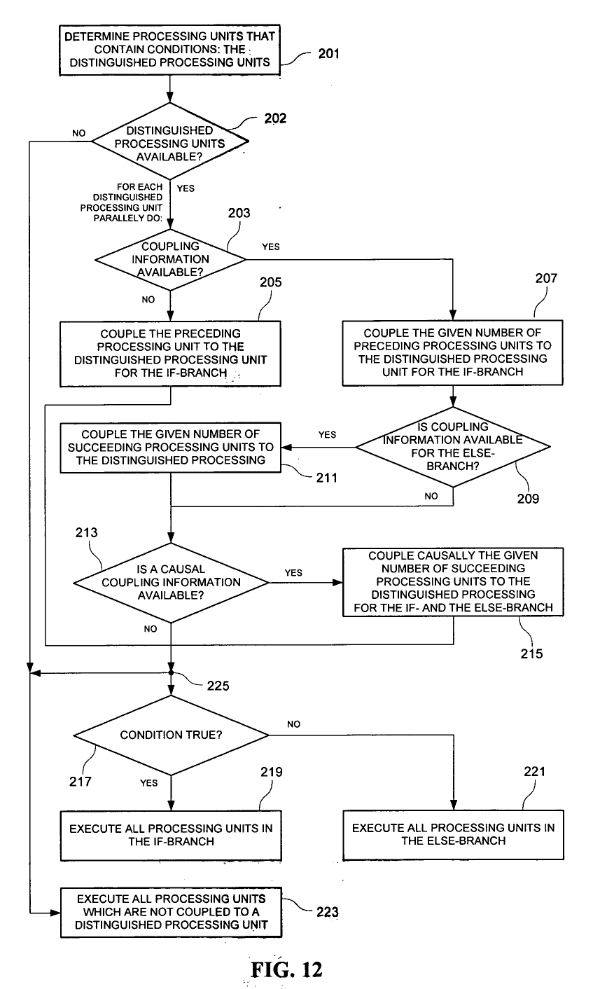

FIG. 12 shows a method for controlling a plurality of processing units. As illustrated by block 201, distinguished processing units of the given set of processing units can be determined. This can be done during a fetch stage, a decode stage, or an execute stage 3 by a unit, a module of a control unit 9. At decision block 202, it can be determined, if a distinguished processing unit is available in the set of processing units. If no distinguished processing unit is available, the processing units can execute their loaded instructions as illustrated by block 223.

If at least one distinguished processing unit is available, for each distinguished processing unit coupling information can be included in the VLIW to determine which processing units are to be coupled to a distinguished processing unit. At decision block 203, it can be determined if coupling information is available. If no coupling information is available, the preceding processing unit (the processing unit with the next lower number in a hierarchy) can be coupled to the distinguished processing unit by default, as illustrated in block 205. If coupling information is available, the number (which is coded in the VLIW) of processing units that are in the ‘if’-branch can be coupled to the distinguished processing unit, as illustrated by block 207.

At decision block 209, it can be determined if coupling information for the ‘else’-branch is available. If coupling information is available for the ‘else’-branch, the number (which is coded in the VLIW) of processing units that are in the ‘else’-branch can be coupled to the distinguished processing unit for the ‘else’-branch, as illustrated in block 211. If no coupling information was available for the ‘else’-branch or after processing block 211, block 213 can determine if causal coupling information is available.

Causal coupling information can determine if and which processing units shall execute its instructions in the next cycles depending on the condition in the distinguished processing unit according to FIG. 11. Such instructions could be instructions which are already processed by the decode stage or the fetch stage. If causal coupling information is available, the given number (which is given in the VLIW) of processing units can be coupled to the distinguished processing units for the ‘if’-branch, the ‘else’-branch, or both, as indicated by block 215.

At decision block 217, it can be determined if the condition of the distinguished processing unit is true or not. If the condition is true, all processing units in the ‘if’-branch can be executed, as illustrated by block 219. If the condition is false, all processing units in the ‘else’-branch can be executed, as illustrated by block 221. Moreover, it is to note, that if-else-if statements can easily be coded using the present disclosure. If the ‘else’-branch of a condition (the processing units coupled to the distinguished processing unit for the ‘else’-branch) again contains a nested condition, the conditional execution according to the nested condition is only executed if the ‘else’-branch mentioned above gets valid. Hence the method of FIG. 12 can be seen as a recursive process and the blocks 219 and 221 start the process at block 201 again for the processing units in the ‘if’- or ‘else’-branch, respectively, until no more distinguished processing units are available which is detected by block 202.

As illustrated by block 223, processing units which are not coupled to any distinguished processing unit can be executed, regularly. Processing units do not depend on (are not coupled to) a distinguished processing unit if no distinguished processing units are available which can be detected by block 202, or if processing units of a given set of processing units are not coupled to any condition, which can be detected at point 225 in the flow. Hence, processing units which are not coupled to any distinguished processing can be executed in parallel, as illustrated by 223.

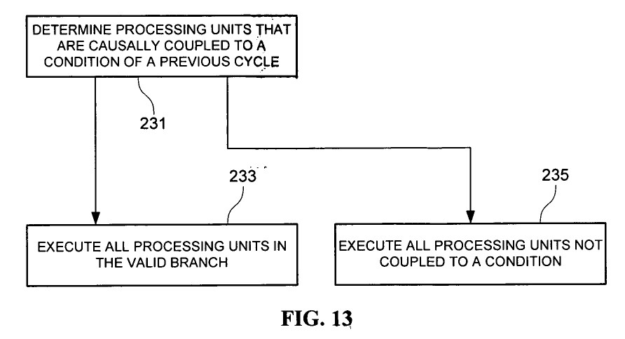

FIG. 13 is a flow diagram that includes a causal conditional execution according to an embodiment of the disclosure for processing units which have been coupled to a condition (of a distinguished processing unit) in a previous processor cycle. As illustrated by block 231, it can be determined which processing units are coupled to a condition (coupled to a distinguished processing unit in a previous processor cycle) which was evaluated in a previous processor cycle. As illustrated by block 233, the processing units can be executed which are in the valid branch of that conditions of a previous cycle.

The valid branch can be the ‘if’- or the ‘else’-branch depending on whether the condition was evaluated to true or to false. Processing units of the branch which is not valid are not executed. As illustrated by block 235, processing units, which are not affected by the conditional execution can be executed regularly. The flow shown in FIG. 13 can in some embodiments be started in parallel to the process of FIG. 12 or in other embodiments by block 223 of the flow diagram of FIG. 12.

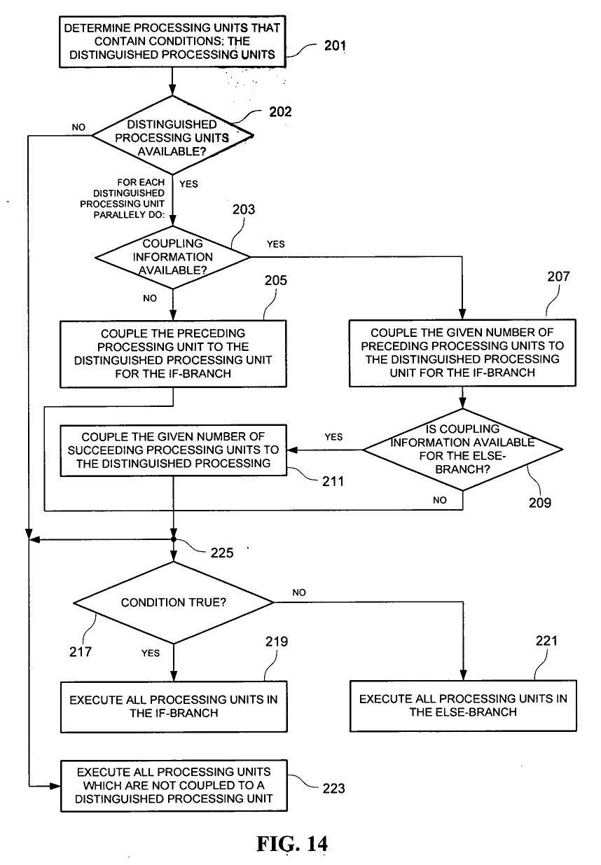

FIG. 14 is a flow diagram similar to the flow diagram of FIG. 12 without causal conditional execution according to another embodiment of the disclosure. Thus blocks 213 and 215 are eliminated. The flow diagram shown in FIG. 14 is identical to FIG. 12 from blocks 201 to 213. At decision block 217, it can be determined if the condition of the distinguished processing unit is true or not. If the condition is true, all processing units in the ‘if’-branch can be executed, as illustrated by block 219. If the condition is false, all processing units in the ‘else’-branch can be executed, as illustrated by block 221. Moreover, as illustrated by block 223, processing units which are not coupled to any distinguished processing unit can be executed, regularly.

The disclosure is not restricted to the described examples. In particular, the disclosure is, if the architecture is appropriately adjusted, applicable also for more than six processing units arranged in parallel. All properties of the disclosure can be combined with each other arbitrarily.

Each process disclosed herein can be implemented with a software program. The software programs described herein may be operated on any type of computer, such as personal computer, server, etc. Any programs may be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet, intranet or other networks. Such signal-bearing media, when carrying computer-readable instructions that direct the functions of the present invention, represent embodiments of the present disclosure.

The disclosed embodiments can take the form of an entirely hardware embodiment, an entirely software embodiment or an embodiment containing both hardware and software elements. In one embodiment, the disclosed method is implemented utilizing software, which includes but is not limited to firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. A data processing system suitable for storing and/or executing program code can include at least one processor, logic, or a state machine coupled directly or indirectly to memory elements through a system bus. The memory elements can include local memory employed during actual execution of the program code, bulk storage, and interrupt memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

It will be apparent to those skilled in the art having the benefit of this disclosure that the present invention contemplates methods, systems, and media that provide interrupt management. It is understood that the form of the invention shown and described in the detailed description and the drawings are to be taken merely as examples. It is intended that the following claims be interpreted broadly to embrace all the variations of the example embodiments disclosed.

What is claimed is:

1. A method for executing a very long instruction word (VLIW) comprising:
loading a VLIW from at least one memory unit into an instruction word decoder;
separating the VLIW into processable sequences, each processable sequence processable by a processing unit among a plurality of processing units;
executing each processable sequence independently in the absence of a condition in the processable sequences; and
coupling processing units together when the processable sequences contains a condition.

2. The method of claim 1, further comprising assigning the processable sequence that contains the condition to a processing unit to create a distinguished processing unit and coupling at least one processing unit of the plurality of processing units to the distinguished processing unit for at least one clock cycle to facilitate processing of the condition and decoupling the at least one processing unit in response to the condition being processed.

3. The method of claim 1, further comprising coupling of at least one processing unit of the plurality of processing units to the distinguished processing unit for at least one future clock cycle and executing the instructions in said coupled processing units in said future clock cycle depending on the result of said distinguished processing unit.

4. The method of claim 1, wherein loading comprises generating a processing unit coupling control signal.

5. The method of claim 1, wherein separating comprises generating a processing unit coupling control signal.

6. The method of claim 1, wherein processing of the instruction having the condition comprises generating coupling signals and wherein coupling comprises hierarchical based coupling when no coupling instructions are available.

7. The method of claim 1, further comprising executing the processable sequence having the condition to determine a result and coupling processing units together in response to a result of the executing.

8. The method of claim 1, further comprising evaluating the condition by a distinguished processing unit and signalling a control unit in response to a result of the condition.

9. The method of claim 8, wherein the control unit can utilize the signal to couple processing units.

10. The method of claim 1, wherein the coupling of processing units is controlled by a control unit.

11. The method of claim 1, further comprising generating a signal indicating how many processing units to couple together in response to the condition being one of met or not met.

12. A very long instruction word (VLIW) processing apparatus comprising:
a memory to store VLIWs;
a decoder to separate the VLIWs into processable sequences, some of the processable sequences having a condition;
a first processing unit coupled to the decoder; and
at least a second processing unit coupled to the decoder, where the first processing unit and the at least a second processing unit each execute processable sequences independently of each other in response to no conditions in the processable sequences and the first processing unit and the at least second processing unit are logically coupled in response to a condition in the processable sequence.

13. The apparatus of claim 12, further comprising a control unit coupled to the first processing unit and to the at least second processing unit and to logically couple the first processing unit to the at least second processing unit in response to the condition.

14. The apparatus of claim 13 wherein the condition has a result that is one of a true result or a false result and the control unit couples the first processing unit to the at least one second processing unit in response to the result.

15. The apparatus of claim 12, further comprising a fetch module coupled to the decoder and to an instruction memory to load the decoder with the VLIW.

16. A computer program product comprising a computer useable medium having a computer readable program, wherein the computer readable program when executed on a computer causes the computer to:
load a VLIW from at least one memory unit into an instruction word decoder;
separate the VLIW into processable sequences, each processable sequence processable by a processing unit from a plurality of processing units, where in the absence of a condition in processable sequence the processing units will process the processable sequences independently; and
couple a processing unit to another processing unit for at least one clock cycle to facilitate processing of a processable sequence with a condition.

17. The computer program product of claim 16, further comprising a computer readable program when executed on a computer causes the computer to decouple the at least one processing unit in response to a control signal.

18. The computer program product of claim 16, further comprising a computer readable program when executed on a computer causes the computer to generate a processing unit coupling control signal.

19. The computer program product of claim 18, further comprising a computer readable program when executed on a computer causes the computer to generate a processing unit coupling control signal.

20. The computer program product of claim 16, further comprising a computer readable program when executed on a computer causes the computer to process the instruction having the condition and generate a coupling signal in response to results of processing the instruction.
